(19) United States
(12) Patent Application Publication
(10) Pub. No.: US 2026/0318094 A1
(43) Pub. Date: Oct. 15, 2026

(54) Concrete Formwork Screw

(71) Applicant: Anast Lawrence Liascos, Tucson, AZ (US)

(72) Inventor: Anast Lawrence Liascos, Tucson, AZ (US)

(21) Appl. No.: 19/090,136

(22) Filed: Mar. 25, 2025

Related U.S. Application Data
(60) Provisional application No. 63/731,021, filed on Mar. 25, 2024.

(51) Int. Cl. E04G 17/065; F16B 23/00

(52) U.S. Cl. CPC E04G 17/0655; F16B 23/0007

(57) ABSTRACT

The Concrete Formwork Screw is a specialized fastener used in construction for securing formwork panels, molds, and temporary structures. The Concrete Formwork Screw comprises a head, a shank and a washer. The shank comprises a bare portion and a threaded portion. The Concrete Formwork Screw is primarily engineered to drive into wood, but the Concrete Formwork Screw can be utilized with other selected materials based on the characteristics of the thread of the threaded portion of the shank.

### (B) CROSS-REFERENCE TO RELATED APPLICATIONS

This application claims the priority benefit of U.S. Provisional Patent Application Ser. No. 63/731,021 filed Mar. 25, 2024.

### (C) STATEMENT REGARDING FEDERALLY SPONSORED R & D

Not Applicable

### (D) THE NAMES OF THE PARTIES TO A JOINT RESEARCH AGREEMENT

Not Applicable

### (E) “SEQUENCE LISTING,” A TABLE, OR A COMPUTER PROGRAM

Not Applicable

### (F) PRIOR DISCLOSURES BY AN INVENTOR OR JOINT INVENTOR

Not Applicable

### (G) BACKGROUND OF THE INVENTION

### (G) 1 Field of the Invention

Concrete formwork screws are specialized fasteners used in construction for securing formwork panels, molds, and temporary structures needed to shape and support wet concrete until the concrete sets. Concrete formwork screws are designed to provide strong, reliable fastening while allowing easy removal and reuse of the formwork.

### (G) 2 Description of Related Art

Concrete formwork screws play a crucial role in construction projects, particularly in the following applications.

When securing formwork panels, concrete formwork screws hold plywood, steel, or plastic formwork panels in place during concrete pouring. They also provide a firm grip, preventing movement or shifting under concrete pressure.

When temporary fastening for supports and braces, concrete formwork screws are used to attach bracing, walers, and ties to stabilize formwork. They ensure alignment and rigidity of the form structure.

When reinforcing column and beam formwork, concrete formwork screws help maintain the shape and structural integrity of vertical and horizontal formwork.

When used as attachment of formwork accessories, concrete formwork secure chamfer strips, reveal strips, and form liners to create architectural finishes.

### (G) 3 Design Features of Concrete Formwork Screws

Concrete formwork screws vary in design based on their intended use, material, and load-bearing requirements. Common design elements include thread design, head type, and material composition.

Thread design can be either coarse threads or fine threads. Coarse threads provide better grip and high holding power in softwood and composite formwork materials, reducing stripping and loosening. Fine threads are ideal for harder materials like steel or hardwood formwork. Fine threads allow for more precise tightening and less damage to the formwork.

Head types include square head, hex head, Phillips and Torx head. Square heads provide a solid grip with wrenches or square-drive tools such as impact drivers, preventing slippage. Hex heads are often used with impact drivers or wrenches, offering high torque and easy removal.

Material composition for concrete formwork screws vary by application. Hardened steel screws provide high tensile strength for heavy-duty formwork applications. Stainless steel screws provide corrosion-resistance and are used in marine or humid environments. Zinc-coated or galvanized screws provide rust resistance, extending their lifespan.

Concrete formwork screws are essential in modern construction due to their strength, ease of use, and reusability. Their various designs cater to different materials and structural needs, ensuring secure and precise fastening for formwork. While they have some limitations, their benefits in terms of efficiency, cost-effectiveness, and durability make them a preferred choice over traditional fastening methods. Proper selection based on material, thread type, and environmental conditions ensures optimal performance and long-lasting results.

### (H) Brief Summary of the Invention

The Concrete Formwork Screw (100) is a specialized fastener used in construction for securing formwork panels, molds, and temporary structures. The Concrete Formwork Screw (100) is primarily engineered to drive into wood, but the Concrete Formwork Screw (100) can be utilized with other selected materials based on the characteristics of the thread (330) of the threaded portion (320) of the shank (300). Other selected materials include dry wall, plywood, steel and plastic.

The Concrete Formwork Screw (100) comprises a head (200), a washer (400), and a shank (300).

### (I) BRIEF DESCRIPTION OF THE SEVERAL VIEWS OF THE DRAWING

FIG. 1 shows a isometric top front right view of the Concrete Formwork Screw (100);

FIG. 2 shows a front view of the Concrete Formwork Screw (100);

FIG. 3 shows a sectional view of the head (200) of the Concrete From Screw (100) taken at the sectional plane and in the direction indicated by section lines 3-3;

FIG. 4 shows a top view of the head (200) of the Concrete Formwork Screw (100);

FIG. 5 shows a front view close up of the tip end (340) of the threaded portion (320) of the shank (300) of the Concrete Formwork Screw (100);

FIG. 6 shows a bottom view of the tip end (340) of the threaded portion (320) of the shank (300) of the Concrete Formwork Screw (100).

### (J) DETAILED DESCRIPTION OF THE INVENTION

The Concrete Formwork Screw (100) is a specialized fastener used in construction for securing formwork panels, molds, and temporary structures. The Concrete Formwork Screw (100) is primarily engineered to drive into wood, but the Concrete Formwork Screw (100) can be utilized with other selected materials based on the characteristics of the thread (330) of the threaded portion (320) of the shank (300). Other selected materials include dry wall, plywood, steel and plastic.

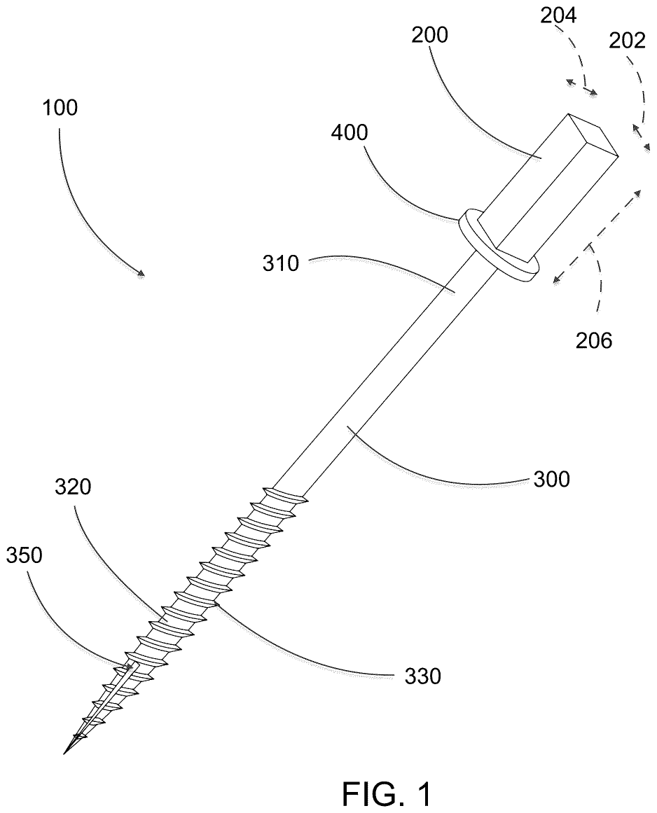

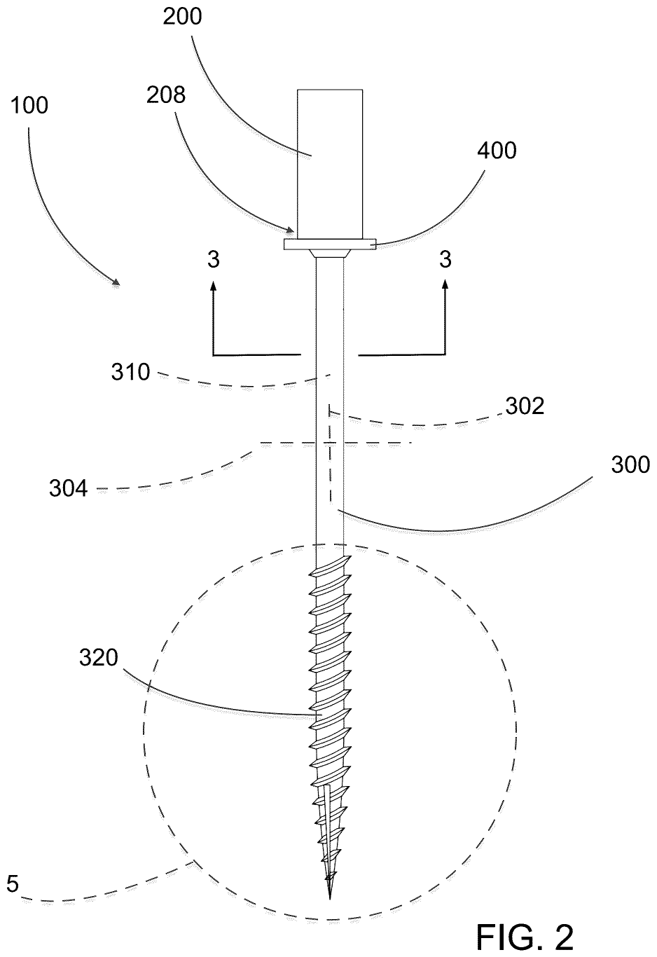

The Concrete Formwork Screw (100) comprises a head (200), a washer (400), and a shank (300). FIG. 1 and FIG. 2 show the Concrete Formwork Screw (100), comprising a head (200), a washer (400), and a shank (300).

The Concrete Formwork Screw (100) is designed so that a socket (90) is inserted over the head (200), and an impact driver (80) rotates the socket (90), driving the Concrete Formwork Screw (100) into the selected material (e.g. wood). An impact driver (80) is the preferred prime mover for the socket (90), delivering higher torque and preventing stripping compared to a drill. However, a drill can also be utilized.

The head (200) is shaped as a regular prism. The head (200) comprises a length (202), a width (204), a height (206) and a base (208). The height (206) of the head (200) is at least two times the length (202) of the head (200), preferably ranging between 2.2 and 2.6 times the length (202) of the head (200). A specific height (206) range that has already been tested and utilized is between 2.41 and 2.43 times the length (202) of the head (200). FIG. 1 and FIG. 2 show relative positioning of the head (200) compared to the rest of the Concrete Formwork Screw (100).

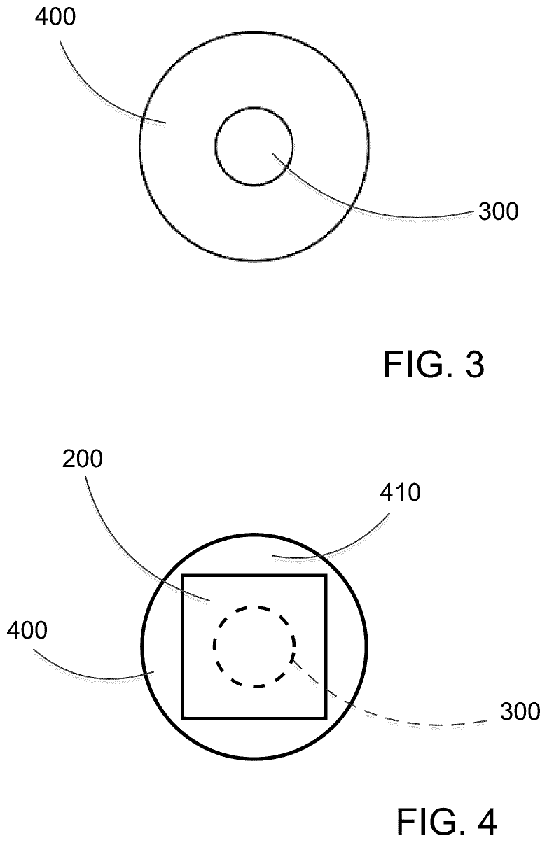

The length (202), the width (204), the height (206) and the base (208) are sized so that standard metric and imperial size sockets can fit over the head (200). For example, the base (208) can be square. In this configuration, square sockets can fit over the head (200). The base (208) can be hex shaped, so that 6-point hex and 12-point sockets can fit the head (200). FIG. 1 shows a head (200) with a square base (208). FIG. 3 shows the top view of the head (200) with a square shape.

The washer (400) is a circular disk that is integrally connected to the base (208) of the head (200). The washer (400) provides a extended surface (410) that stops the movement of the socket (90) into the head (200), securing the socket (90) as the impact driver (80) rotates the socket (90), driving the Concrete Formwork Screw (100) into the selected material.

The washer (400) comprises a diameter (402). The diameter (402) of the washer (400) is sized so that the washer (400) extends out from the base (208) of the head (200), creating an extended surface (410). This extended surface (410) secures the socket (90) as the impact driver (80) rotates the socket (90), driving the Concrete Formwork Screw (100) into the selected material. FIG. 4 shows the bottom view of the washer (400), with the extended surface (410).

The shank (300) comprises of a vertical axis (302), a horizontal axis (304), a height (306), a bare portion (310), and a threaded portion (320). FIG. 2 shows the shank (300) with the bare portion (310) and the threaded portion (320).

The bare portion (310) comprises a height (312).

The threaded portion (320) comprises a height (322), a thread (330), a tip end (340), and a slot (350). FIG. 2 shows the threaded portion (320) with the thread (330) and the tip end (340).

The height (306) of the shank (300) equals the height (312) of the bare portion (310) plus the height (322) of the threaded portion (320). The length (322) of the threaded portion (320) is preferably less than fifty five percent (55%) of the length of the shank (300).

The thread (330) of the threaded portion (320) of the shank (300) has typical shape, size, spacing, and direction characteristics for wood use. The thread characteristics can be changed so that the Concrete Formwork Screw (100) can be used with other selected materials.

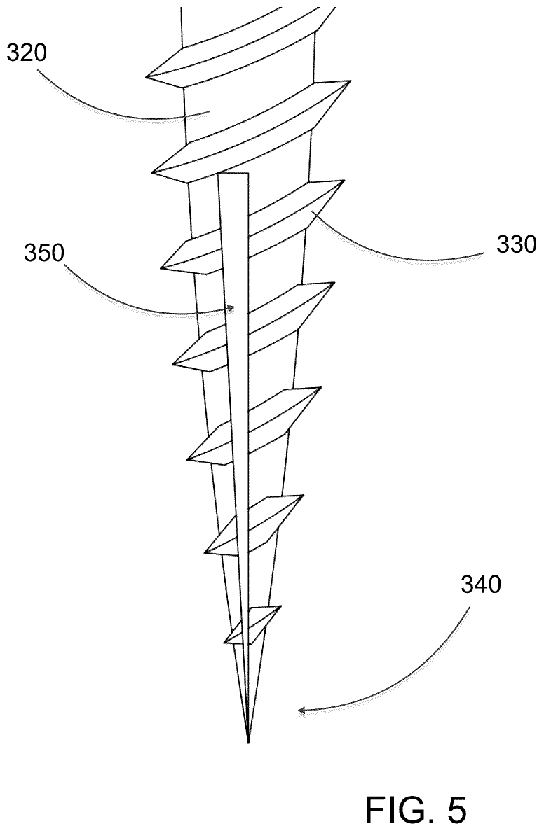

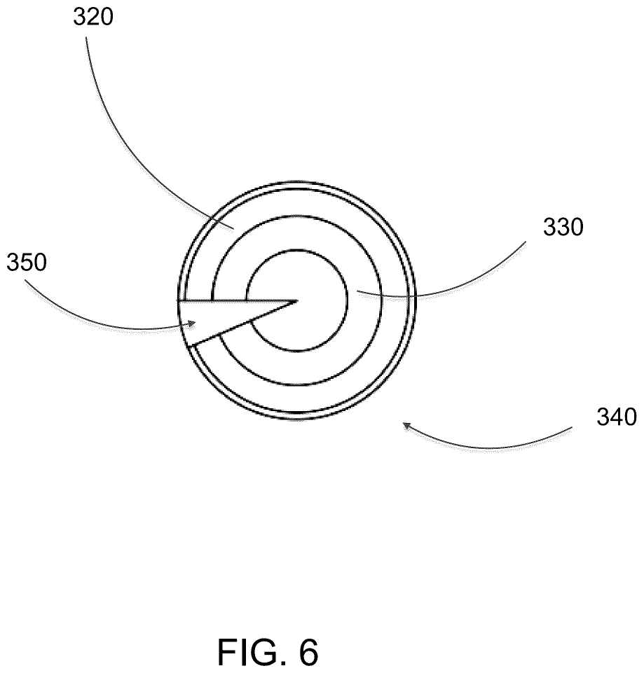

The slot (350) is located at the tip end (340) of the threaded portion (320) of the shank (300). FIG. 5 shows the position of the slot (350) relative to the tip end (340) of the threaded portion (320) of the shank (300). FIG. 6 shows the bottom view of the tip end (340) of the threaded portion (320) and the slot (350). The slot (350) is aligned to the vertical axis (302) of the shank (300). The slot (350) enables the Concrete Formwork Screw (100) to tap its own hole (self-tapping), acting like a built-in drill bit and allowing it to cut into wood and reduce splitting, minimizing the risk of material damage. The slot (350) removes debris as the Concrete Formwork Screw (100) penetrates, improving efficiency, reducing resistance and preventing jamming. The slot (350)helps slice through woodfibers, making it easier to drive without pre-drilling.

A preferred type of self tapping screw with a slot (350) is called the Type 17 slot.

However, there are other types of self tapping screws such as:
Type A—Sharp-pointed with coarse threads, used for soft materials like wood and thin metals.
Type AB—Similar to Type A but with finer threads, providing better grip in thin sheet metal or plastic.
metals. Type B—Blunt point with fine threads, requiring a pre-drilled hole; used for thick
Type C—Machine screw threads with a blunt point; requires pre-drilled holes in harder materials.
Type D, F, G, H, and T—Variations designed for harder materials, usually requiring pre-drilled holes.
Type 17—Has a cut-out slot near the tip for easier wood penetration, commonly used in decking screws.
metals. Type 23 & 25—Self-tapping screws with a built-in cutting edge, ideal for plastics and
Type U—Has a unique “spade” point for softer materials like drywall and particleboard.

Each type is designed to either cut its own threads or work best in pre-drilled holes, depending on the application. Do you need a recommendation for a specific material or job?

### (J) 1 Clarifying Comments

While the foregoing written description of the invention enables a person having ordinary skill in the art to make and use what is considered presently to be the best mode thereof, those of ordinary skill in the art will understand and appreciate the existence of variations, combinations, and equivalents of the specific embodiment, process, and examples herein. The invention should therefore not be limited by the above described embodiment, process, and examples, but by all embodiments and processes within the scope and spirit of the invention.

The inventions shown and described herein may be used to address one or more of such problems or other problems not set out herein and/or which are only understood or appreciated at a later time. The future may also bring to light currently unknown or unrecognized benefits which may be appreciated, or more fully appreciated, in association with the inventions shown and described herein. The desires and expected benefits explained herein are not admissions that others have recognized such prior needs, since invention and discovery are both inventive under the law and may relate to the inventions described herein. (K) CLAIMS

1. The concrete formwork screw designed to secure wood forms, the concrete formwork screw comprising:
(a) a head; the head comprising:
(i) a length;
(ii) a width;
(iii) a height; and
(iv) a base;
(b) a washer; the washer comprising:
(i) a diameter;
(c) a shank, the shank comprising:
(i) a height;
(ii) a vertical axis; and
(iii) a horizontal axis;
(iv) a bare portion, the bare portion comprising:
(1) a height;
(v) a threaded portion, the threaded portion comprising:
(1) a height;
(2) a thread,
(3) a tip end; and
(4) a slot;
(vi) where the slot is located at the tip end of the threaded portion and aligned to the vertical axis of the shank,
(d) where the washer is integrally attached to the base of the head;
(e) where the height of the shank is the addition of the height of the bare portion and the height of the threaded portion,
(f) where the height of the threaded portion is less than fifty percent of the height of the shank.

2. The concrete formwork screw described in claim 1,
(a) where the base of the head is square shaped;
(b) where the height of the threaded portion is less than forty percent of the height of the shank;
(c) where the washer extends out from the base of the head creating four extended surfaces.

3. The concrete formwork screw described in claim 2,
(a) where diameter of the washer is sized so that the washer extends out from the base of the head and creates an extended surface.

4. The concrete formwork screw described in claim 3,
(a) where the height of the head is at least two times the length of the head.

5. The concrete formwork screw described in claim 4,
(a) where the height of the head ranges between 2.2 and 2.6 times the length of the head.

6. The concrete formwork screw described in claim 5,
(a) where the height of the head ranges between 2.41 and 2.43 times the length of the head.

7. The concrete formwork screw described in claim 3,
(a) where the length of the threaded portion is less than fifty five percent of the length of the shank.
